(19) United States
(12) Patent Application Publication
(10) Pub. No.: US 2019/0370187 A1
(43) Pub. Date: Dec. 5, 2019

(54) Cache Replacement Method, Apparatus, and System

(71) Applicant: Huawei Technologies Co., Ltd., Shenzhen (CN)

(72) Inventors: Jiyang Yu, Shenzhen (CN); Lei Fang, Hangzhou (CN); Weiguang Cai, Hangzhou (CN)

(21) Appl. No.: 16/544,352

(22) Filed: Aug. 19, 2019

Related U.S. Application Data
(63) Continuation of application No. PCT/CN2017/075952, filed on Mar. 8, 2017.

(51) Int. Cl. G06F 12/123

(52) U.S. Cl. CPC G06F 12/123; G06F 2212/1044

(57) ABSTRACT

A cache replacement method implemented in a computer including a high-level cache and a low-level cache. The low-level cache and the high-level cache are in an inclusion relationship. The method includes selecting a first cache line in the low-level cache as a to-be-replaced cache line, monitoring whether a hit on a corresponding cache line of the first cache line occurs in the high-level cache, if the hit on the corresponding cache line of the first cache line occurs in the high-level cache before a cache miss occurs in the low-level cache, retaining the first cache line in the low-level cache, and selecting a second cache line as the to-be-replaced cache line. Access to the high-level cache is monitored.

### CROSS-REFERENCE TO RELATED APPLICATION

This application is a continuation of International Patent Application No. PCT/CN2017/075952, filed on Mar. 8, 2017, the disclosure of which is hereby incorporated by reference in its entirety.

### TECHNICAL FIELD

This application relates to the computer field, and in particular, to a cache replacement method, apparatus, and system.

### BACKGROUND

A processor usually uses a plurality of levels of central processing unit (CPU) caches to reduce overheads (time or energy) of accessing data from a primary storage (primary storage) (for example, a system memory). There are usually three types of relationships between the plurality of levels of caches, “inclusive” (inclusive), “exclusive” (exclusive), and “non-inclusive” (non-inclusive) between “inclusive” and “exclusive”. “Inclusive” refers to when each cache line (cache line) in a high-level cache has a corresponding cache line (with a same identifier) in a low-level cache. “Exclusive” refers to when a cache line in a high-level cache and a cache line in a low-level cache are mutually exclusive. “Non-inclusive” is a compromise between “inclusive” and “exclusive”, and refers to when some cache lines in a high-level cache are the same as some cache lines in a low-level cache.

In an inclusive cache, data in a high-level cache is a subset of data in a low-level cache. If a cache line in the low-level cache is evicted, to maintain an inclusion relationship, back invalidation is performed on a corresponding cache line in the high-level cache.

For a data cache, to maintain a coherence protocol, the inclusion relationship may be applied between a low-level cache and a high-level cache. An L1 cache and an L2 cache are used as an example. When the L2 cache includes the L1 cache, if a cache line in the L1 cache is frequently accessed, the cache line is usually stored in the L1 cache for a relatively long time, and no cache miss occurs. However, the L2 cache does not know use of cache lines in the L1 cache. The L2 cache can learn which data needs to be accessed from the L1 cache only when a cache miss occurs in the L1 cache. If a cache line is frequently accessed from the L1 cache and no cache miss occurs, a cache line, corresponding to the frequently accessed cache line, in the L2 cache is evicted from the L2 cache through replacement according to a replacement policy of the L2 cache because the cache line has not been used for a long time. Replacement of the cache line in the L2 cache further triggers back invalidation of the corresponding cache line in the L1 cache. Back invalidation of frequently accessed data in the L1 cache further causes a cache miss in the L1 cache. Consequently, system performance is affected.

### SUMMARY

In view of this, this application discloses a cache replacement method, apparatus, and system, to reduce a possibility of back invalidation of a frequently accessed cache line in a high-level cache by monitoring access to the high-level cache.

According to a first aspect, this application provides a cache replacement method in a computer. The computer includes a high-level cache and a low-level cache. The low-level cache and the high-level cache are in an inclusion relationship. In an embodiment, each cache line in the high-level cache has a corresponding same cache line in the low-level cache. The method includes selecting, by a processor, a first cache line in the low-level cache as a to-be-replaced cache line, monitoring whether a cache hit on a corresponding cache line of the first cache line occurs in the high-level cache, and if the hit on the corresponding cache line of the first cache line occurs in the high-level cache before a cache miss occurs in the low-level cache, retaining the first cache line in the low-level cache, and selecting a second cache line as the to-be-replaced cache line. The to-be-replaced cache line is evicted from the low-level cache when a cache miss occurs in the low-level cache, to release a space for a missing cache line. The corresponding cache line of the first cache line is a cache line the same as the first cache line, and the first cache line and the corresponding cache line of the first cache line include the same data and correspond to a same access address.

If the hit on the corresponding cache line of the first cache line occurs in the high-level cache before a cache miss occurs in the low-level cache, it indicates that data corresponding to the first cache line (the first cache line and the corresponding cache line of the first cache line include the same data) is frequently accessed data in the high-level cache, the to-be-replaced cache line is selected from the low-level cache, to avoid that the first cache line is replaced within a short time such that back invalidation is not performed on the corresponding cache line of the first cache line within a short time, thereby ensuring a high cache hit rate in the high-level cache.

According to the first aspect, in a first possible implementation of the first aspect, the computer further includes a status register, and the status register is associated with the high-level cache and configured to store an identifier of a cache line in a monitored state. A cache line being in a monitored state means that the processor monitors whether a cache hit on the cache line in the high-level cache occurs. After the selecting a first cache line in the low-level cache as a to-be-replaced cache line, the method further includes writing, by the processor, an identifier of the first cache line into the status register. The processor compares an identifier of a hit cache line in the high-level cache with the identifier, stored in the status register, of the first cache line, to determine whether the hit on the corresponding cache line of the first cache line occurs. If the two identifiers are the same, it indicates that the hit on the corresponding cache line of the first cache line occurs.

After the hit on the corresponding cache line of the first cache line occurs or back invalidation is performed on the corresponding cache line of the first cache line, the processor deletes the identifier, recorded in the status register, of the first cache line, to stop monitoring the corresponding cache line of the first cache line.

According to the first aspect, in a second possible implementation of the first aspect, each cache line in the high-level cache corresponds to an indication flag bit, when the indication flag bit is in a first state (for example, 0), it indicates that the corresponding cache line is not in a monitored state, and when the indication flag bit is in a second state (for example, 1), it indicates that the corresponding cache line is in a monitored state. After the selecting a first cache line in the low-level cache as a to-be-replaced cache line, the method further includes searching, by the processor, the high-level cache for the corresponding cache line of the first cache line, and setting an indication flag bit corresponding to the corresponding cache line of the first cache line to the second state.

After the hit on the corresponding cache line of the first cache line occurs or back invalidation is performed on the corresponding cache line of the first cache line, the processor sets the indication flag bit corresponding to the corresponding cache line of the first cache line to the first state, to stop monitoring the corresponding cache line of the first cache line. At a same moment, only one cache line in the high-level cache is in a monitored state.

In an embodiment, the indication flag bit may be implemented by extending a tag by a bit in the high-level cache. The processor checks whether an indication flag bit corresponding to a hit cache line is in the second state, to determine whether the hit on the corresponding cache line of the first cache line occurs. If the indication flag bit corresponding to the hit cache line is in the second state, it indicates that the hit on the corresponding cache line of the first cache line occurs.

According to the first aspect or either of the foregoing possible implementations of the first aspect, in a third possible implementation of the first aspect, the method further includes, if access to the corresponding cache line of the first cache line does not occur in the high-level cache before a cache miss occurs in the low-level cache, when the cache miss occurs in the low-level cache, evicting, by the processor, the first cache line from the low-level cache, and moving a missing cache line into the low-level cache.

If the high-level cache includes the corresponding cache line of the first cache line, and the hit on the corresponding cache line of the first cache line does not occur in the high-level cache before a cache miss occurs in the low-level cache, when the cache miss occurs in the low-level cache, the first cache line is evicted from the low-level cache, and back invalidation is performed on the corresponding cache line, in the high-level cache, of the first cache line. If the high-level cache does not include the corresponding cache line of the first cache line, and access to the corresponding cache line of the first cache line does not occur in the high-level cache before a cache miss occurs in the low-level cache, in other words, a cache miss does not occur on the corresponding cache line of the first cache line before a cache miss occurs in the low-level cache, the first cache line is evicted from the low-level cache when the cache miss occurs in the low-level cache.

According to the third possible implementation of the first aspect, in a fourth possible implementation of the first aspect, after the evicting the first cache line from the low-level cache, the method further includes invalidating, by the processor, the corresponding cache line, in the high-level cache, of the first cache line.

Because the first cache line is evicted from the low-level cache, to ensure the inclusion relationship between the low-level cache and the high-level cache, the processor performs back invalidation on the corresponding cache line of the first cache line.

According to the first aspect or any one of the foregoing possible implementations of the first aspect, in a fifth possible implementation of the first aspect, the processor selects the first cache line in the low-level cache as the to-be-replaced cache line according to a least recently used (LRU) policy.

According to the fifth possible implementation of the first aspect, in a sixth possible implementation of the first aspect, if the hit on the corresponding cache line of the first cache line occurs in the high-level cache before a cache miss occurs in the low-level cache, the method further includes updating, by the processor, a status of the first cache line in the low-level cache to “most recently used” (MRU).

Because the hit on the corresponding cache line of the first cache line occurs in the high-level cache, according to time and space characteristics of cache access, it indicates that the corresponding cache line of the first cache line is frequently accessed data in the high-level cache. To avoid that back invalidation is performed on the corresponding cache line of the first cache line within a short time, the status of the first cache line is updated to MRU such that the first cache line stays longer in the low-level cache.

According to a second aspect, this application provides a cache replacement apparatus in a computer. The computer includes a high-level cache and a low-level cache. The low-level cache and the high-level cache are in an inclusion relationship. The apparatus includes a selection unit, configured to select a first cache line in the low-level cache as a to-be-replaced cache line, where the to-be-replaced cache line is evicted from the low-level cache when a cache miss occurs in the low-level cache, and a monitoring unit, configured to monitor whether a hit on a corresponding cache line of the first cache line occurs in the high-level cache. If the hit on the corresponding cache line of the first cache line occurs in the high-level cache before a cache miss occurs in the low-level cache, the selection unit is further configured to retain the first cache line in the low-level cache, and select a second cache line as the to-be-replaced cache line.

According to the second aspect, in a first possible implementation of the second aspect, the computer further includes a status register, and the status register is associated with the high-level cache and configured to store an identifier of a cache line in a monitored state. The apparatus further includes a write unit. After the selection unit selects the first cache line in the low-level cache as the to-be-replaced cache line, the write unit is configured to write an identifier of the first cache line into the status register. The monitoring unit is configured to compare an identifier of a hit cache line in the high-level cache with the identifier, stored in the status register, of the first cache line. If the two identifiers are the same, it indicates that the hit on the corresponding cache line of the first cache line occurs.

According to the second aspect, in a second possible implementation of the second aspect, each cache line in the high-level cache corresponds to an indication flag bit, when the indication flag bit is in a first state, it indicates that the corresponding cache line is not in a monitored state, and when the indication flag bit is in a second state, it indicates that the corresponding cache line is in a monitored state. After the selection unit selects the first cache line in the low-level cache as the to-be-replaced cache line, the monitoring unit is further configured to search the high-level cache for the corresponding cache line of the first cache line, and set an indication flag bit corresponding to the corresponding cache line of the first cache line to the second state.

According to the second aspect or either of the foregoing possible implementations of the second aspect, in a third possible implementation of the second aspect, the apparatus further includes the write unit. If access to the corresponding cache line of the first cache line does not occur in the high-level cache before a cache miss occurs in the low-level cache, when the cache miss occurs in the low-level cache, the write unit is further configured to evict the first cache line from the low-level cache, and move a missing cache line into the low-level cache.

According to the third possible implementation of the second aspect, in a fourth possible implementation of the second aspect, the apparatus further includes an invalidation unit. After the write unit evicts the first cache line from the low-level cache, the invalidation unit is configured to invalidate the corresponding cache line, in the high-level cache, of the first cache line.

According to the second aspect or any one of the foregoing possible implementations of the second aspect, in a fifth possible implementation of the second aspect, the selection unit is configured to select the first cache line in the low-level cache as the to-be-replaced cache line according to a least recently used LRU policy.

According to the fifth possible implementation of the second aspect, in a sixth possible implementation of the second aspect, if the hit on the corresponding cache line of the first cache line occurs in the high-level cache before a cache miss occurs in the low-level cache, the selection unit is further configured to update a status of the first cache line in the low-level cache to “MRU”.

The second aspect or any possible implementation of the second aspect is an apparatus implementation corresponding to the first aspect or any possible method implementation of the first aspect, the description in the first aspect or any possible implementation of the first aspect is correspondingly applicable to the second aspect or any possible implementation of the second aspect, and details are not described herein again.

According to a third aspect, this application provides a cache replacement system. The system includes a high-level cache, a low-level cache, and a cache controller. The low-level cache and the high-level cache are in an inclusion relationship. The cache controller is configured to select a first cache line in the low-level cache as a to-be-replaced cache line, where the to-be-replaced cache line is evicted from the low-level cache when a cache miss occurs in the low-level cache, monitor whether a hit on a corresponding cache line of the first cache line occurs in the high-level cache, and if the hit on the corresponding cache line of the first cache line occurs in the high-level cache before a cache miss occurs in the low-level cache, retain the first cache line in the low-level cache, and select a second cache line as the to-be-replaced cache line.

According to the third aspect, in a first possible implementation of the third aspect, the system further includes a status register, and the status register is associated with the high-level cache and configured to store an identifier of a cache line in a monitored state. After selecting the first cache line in the low-level cache as the to-be-replaced cache line, the cache controller is further configured to write an identifier of the first cache line into the status register. The cache controller is configured to compare an identifier of a hit cache line in the high-level cache with the identifier, stored in the status register, of the first cache line. If the two identifiers are the same, it indicates that the hit on the corresponding cache line of the first cache line occurs.

According to the third aspect, in a second possible implementation of the third aspect, each cache line in the high-level cache corresponds to an indication flag bit, when the indication flag bit is in a first state, it indicates that the corresponding cache line is not in a monitored state, and when the indication flag bit is in a second state, it indicates that the corresponding cache line is in a monitored state. After selecting the first cache line in the low-level cache as the to-be-replaced cache line, the cache controller is further configured to search the high-level cache for the corresponding cache line of the first cache line, and set an indication flag bit corresponding to the corresponding cache line of the first cache line to the second state.

According to the third aspect or either of the foregoing possible implementations of the third aspect, in a third possible implementation of the third aspect, if access to the corresponding cache line of the first cache line does not occur in the high-level cache before a cache miss occurs in the low-level cache, the cache controller is further configured to, when the cache miss occurs in the low-level cache, evict the first cache line from the low-level cache, and move a missing cache line into the low-level cache.

According to the third possible implementation of the third aspect, in a fourth possible implementation of the third aspect, after evicting the first cache line from the low-level cache, the cache controller is further configured to invalidate the corresponding cache line, in the high-level cache, of the first cache line.

According to the third aspect or any one of the foregoing possible implementations of the third aspect, in a fifth possible implementation of the third aspect, the cache controller is configured to select the first cache line in the low-level cache as the to-be-replaced cache line according to a least recently used LRU policy.

According to the fifth possible implementation of the third aspect, in a sixth possible implementation of the third aspect, if the hit on the corresponding cache line of the first cache line occurs in the high-level cache before a cache miss occurs in the low-level cache, the cache controller is further configured to update a status of the first cache line in the low-level cache to “most recently used MRU”.

The third aspect or any possible implementation of the third aspect is a system implementation corresponding to the first aspect or any possible method implementation of the first aspect, the description in the first aspect or any possible implementation of the first aspect is correspondingly applicable to the third aspect or any possible implementation of the third aspect, and details are not described herein again.

According to the technical solutions disclosed in this application, after selecting the first cache line in the low-level cache as the to-be-replaced cache line, the processor monitors whether a hit on the corresponding cache line of the first cache line occurs in the high-level cache. If the hit on the corresponding cache line of the first cache line occurs, it indicates that the corresponding cache line of the first cache line is frequently accessed data (hot data) in the high-level cache. The processor retains the first cache line in the low-level cache, and selects the second cache line as the to-be-replaced cache line, thereby ensuring that the corresponding cache line, which is hot data, of the first cache line is not invalidated in the high-level cache due to replacement in the low-level cache, increasing a cache hit rate in the high-level cache, and improving overall system performance.

### BRIEF DESCRIPTION OF DRAWINGS

FIG. 1 is a schematic diagram of a logical structure of a computer according to an embodiment of the present disclosure.

FIG. 2A and FIG. 2B are schematic diagrams of a cache structure according to an embodiment of the present disclosure.

FIG. 3 is an example flowchart of a cache replacement method according to an embodiment of the present disclosure.

FIG. 4 is an example flowchart of a cache replacement method according to an embodiment of the present disclosure.

FIG. 5A and FIG. 5B are example flowcharts of a cache replacement method according to an embodiment of the present disclosure.

FIG. 6 is a schematic diagram of a logical structure of a cache replacement system according to an embodiment of the present disclosure.

FIG. 7 is a schematic diagram of a logical structure of a cache replacement apparatus according to an embodiment of the present disclosure.

FIG. 8 is a schematic diagram of a logical structure of a cache replacement apparatus according to an embodiment of the present disclosure.

### DESCRIPTION OF EMBODIMENTS

The following describes embodiments of the present disclosure with reference to accompanying drawings.

In a conventional cache replacement policy, a to-be-replaced cache line may be selected from a low-level cache according to a least recently used policy. A first cache line is in the low-level cache (for example, an L2 cache). A corresponding cache line of the first cache line is in a high-level cache (for example, an L1 cache). The corresponding cache line of the first cache line is a cache line the same as the first cache line, and the first cache line and the corresponding cache line of the first cache line include same data and correspond to a same access address. If a processor frequently accesses data corresponding to the first cache line, a cache hit on the corresponding cache line of the first cache line frequently occurs in the L1 cache. Data corresponding to a cache line is memory data included in the cache line. The first cache line and the corresponding cache line of the first cache line include the same data. If the corresponding cache line of the first cache line is frequently hit in the L1 cache, according to the LRU policy, the corresponding cache line of the first cache line stays in the L1 cache, and the first cache line in the L2 cache is not accessed. If the first cache line in the L2 cache has not been accessed for a period of time, according to the LRU replacement policy, a risk of replacing the first cache line in the L2 cache is gradually increased. After the first cache line in the L2 cache is determined as the to-be-replaced cache line, when a cache miss occurs in the L2 cache, the first cache line needs to be evicted from the L2 cache, and to ensure an inclusion relationship, back invalidation is performed on the corresponding cache line, in the L1 cache, of the first cache line. If the data corresponding to the first cache line is frequently accessed data in the L1 cache, a cache miss on the corresponding cache line of the first cache line occurs soon in the L1 cache, and the data corresponding to the first cache line needs to be rewritten into the L2 cache and the L1 cache. Consequently, overall system performance is affected.

To resolve the foregoing problem, in the technical solutions disclosed in the embodiments of the present disclosure, after a first cache line in a low-level cache is determined as a to-be-replaced cache line, a processor monitors whether a cache hit on a corresponding cache line of the first cache line occurs in a high-level cache. If the hit on the corresponding cache line of the first cache line occurs in the high-level cache before the first cache line is replaced because a cache miss occurs in the low-level cache, the corresponding cache line of the first cache line may be frequently accessed from the high-level cache according to time and space characteristics of cache access. Therefore, the first cache line is retained in the low-level cache, and a second cache line is selected as the to-be-replaced cache line. Back invalidation of the corresponding cache line of the first cache line is avoided, the corresponding cache line of the first cache line stays in the high-level cache, and a high overall cache hit rate is ensured. If the high-level cache includes the corresponding cache line of the first cache line, and the cache hit on the corresponding cache line of the first cache line does not occur in the high-level cache before a cache miss occurs in the low-level cache, it indicates that the corresponding cache line of the first cache line is not frequently accessed from the high-level cache. Therefore, when the cache miss occurs in the low-level cache, the first cache line is evicted from the low-level cache through replacement, and back invalidation is performed on the corresponding cache line, in the high-level cache, of the first cache line. In the embodiments of the present disclosure, evicting the first cache line from the low-level cache through replacement includes evicting the first cache line from the low-level cache, and writing a missing cache line into the low-level cache.

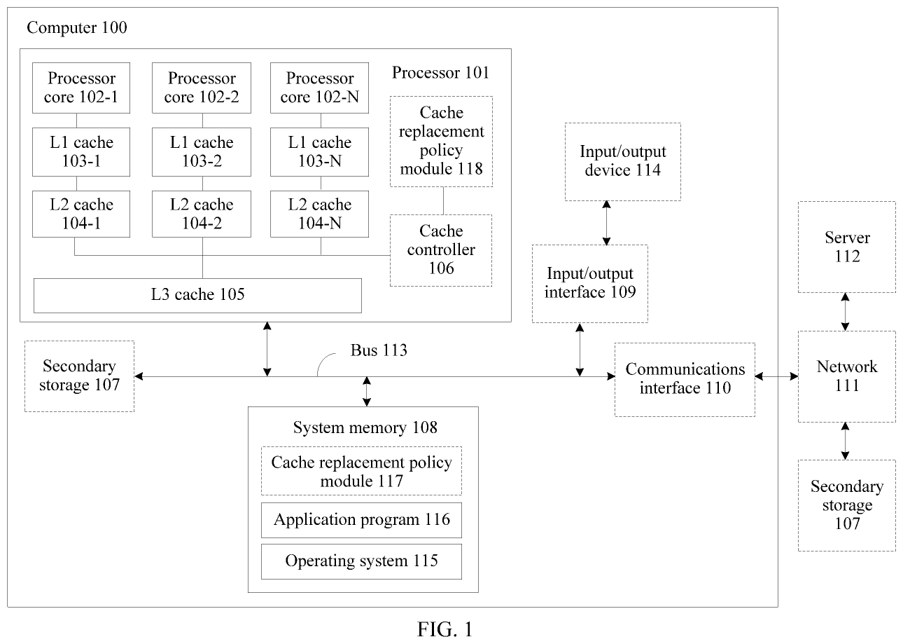

FIG. 1 is a schematic structural diagram of a computer 100 according to an embodiment of the present disclosure. The computer may be any electronic device, for example, a portable computer, a desktop computer, a server, a network device, a tablet computer, a mobile phone, a personal digital assistant (PDA), a wearable device, or any combination thereof.

As shown in FIG. 1, the computer 100 includes a processor 101. The processor 101 is connected to a system memory 108. The processor 101 may be a CPU, a graphics processing unit (GPU), or a digital signal processor (DSP).

The processor 101 may be a single-core processor or a multi-core processor, and includes two or more levels of caches. In this embodiment of the present disclosure, the processor 101 includes a plurality of processor cores 102 (including a processor core 102-1, a processor core 102-2, and a processor core 102-N, which are collectively referred to as the processor core 102) and a three-level cache architecture. An L1 cache 103 (including an L1 cache 103-1, an L1 cache 103-2, and an L1 cache 103-N, which are collectively referred to as the L1 cache 103) and an L2 cache 104 (including an L2 cache 104-1, an L2 cache 104-2, and an L2 cache 104-N, which are collectively referred to as the L2 cache 104) are private caches. An L3 cache 105 is a shared cache. The private caches can be used only by corresponding processor cores, and the shared cache can be shared among the plurality of processor cores. The L1 cache 103 is a high-level cache relative to the L2 cache 104 and the L3 cache 105. The L2 cache is a high-level cache relative to the L3 cache. The L2 cache 104 and the L3 cache 105 are low-level caches relative to the L1 cache 103. The L3 cache 105 is a low-level cache relative to the L2 cache 104. In this embodiment of the present disclosure, a low-level cache and a high-level cache are in an inclusion relationship, and each cache line in the high-level cache is also in a corresponding low-level cache.

The processor 101 may further include a cache controller 106. The cache controller 106 is configured to select a corresponding data unit (cache line) based on different types of message requests and address information corresponding to the requests, and perform an operation such as reading, updating, or padding on the data unit. During a specific implementation, each level of cache may have its own control logic, cache controllers 106 shown in FIG. 1 may be distributedly deployed in different levels of caches, or one cache architecture may have overall control logic. This is not limited in this embodiment of the present disclosure. The cache controller 106 may be integrated into the processor 101 as an independent component, or may be integrated into the processor core 102, and the processor core 102 implements a function of the cache controller 106.

In an embodiment of the present disclosure, the processor 101 may further include a cache replacement policy module 118. The cache replacement policy module 118 is a firmware module integrated into the processor 101. The processor 101 or the cache controller 106 executes firmware code in the cache replacement policy module 118 to implement the technical solutions in the embodiments of the present disclosure. The cache replacement policy module 118 includes, (1) code for selecting a first cache line in a low-level cache as a to-be-replaced cache line, (2) code for monitoring whether a cache hit on a corresponding cache line of the first cache line occurs in a high-level cache after the first cache line in the low-level cache is selected as the to-be-replaced cache line and before the first cache line is replaced because a cache miss occurs in the low-level cache, and (3) code for retaining the first cache line in the low-level cache and selecting a second cache line as the to-be-replaced cache line if the cache hit on the corresponding cache line of the first cache line occurs in the high-level cache before a cache miss occurs in the low-level cache.

A bus 113 is configured to transfer information between components of the computer 100. The bus 113 may implement communication in a wired or wireless manner. This is not limited in this application. The bus 113 may be further connected to a secondary storage (secondary storage) 107, an input/output interface 109, and a communications interface 110.

A storage medium of the secondary storage 107 may be a magnetic medium (for example, a floppy disk, a hard disk, or a magnetic tape), an optical medium (for example, an optical disc), a semiconductor medium (for example, a solid state disk (SSD)), or the like. In some embodiments, the secondary storage 107 may further include a remote storage separated from the processor 101, for example, a web disk (including a network or cluster file system such as a network file system (NFS)) that accesses a communications network 111 using the communications interface 110 and a network storage protocol.

The input/output interface 109 connected to an input/output device 114 is configured to receive input information and output an operation result. The input/output device 114 may be a mouse, a keyboard, a display, an optical drive, or the like.

The communications interface 110 implements communication with another device or the communications network 111 using, for example but not limited to, a transceiver apparatus such as a transceiver. The communications interface 110 may be interconnected with the network 111 in a wired or wireless manner. The network 111 may be the Internet, an intranet, a local area network (LAN), a wide area network (wide area network, WAN), a storage area network (SAN), or any combination of these networks.

Some features of the embodiments of the disclosure may be completed/supported by the processor 101 by executing software code in the system memory 108. The system memory 108 may include some software, for example, an operating system 115 (for example, DARWIN, RTXC, LINUX, UNIX, OS X, WINDOWS, or an embedded operating system (for example, VXWORKS)), an application program 116, and a cache replacement policy module 117.

In an embodiment of the present disclosure, the processor 101 or the cache controller 106 executes the cache replacement policy module 117 to implement the technical solutions in the embodiments of the present disclosure. The cache replacement policy module 117 includes, (1) code for selecting a first cache line in a low-level cache as a to-be-replaced cache line, (2) code for monitoring whether a cache hit on a corresponding cache line of the first cache line occurs in a high-level cache after the first cache line in the low-level cache is selected as the to-be-replaced cache line and before the first cache line is actually replaced because a cache miss occurs in the low-level cache, and (3) code for retaining the first cache line in the low-level cache and selecting a second cache line as the to-be-replaced cache line if the cache hit on the corresponding cache line of the first cache line occurs in the high-level cache before a cache miss occurs in the low-level cache.

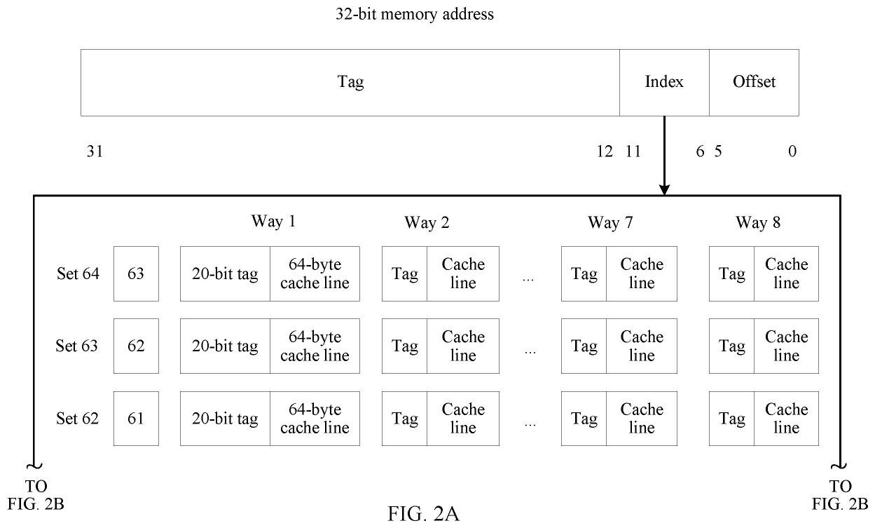

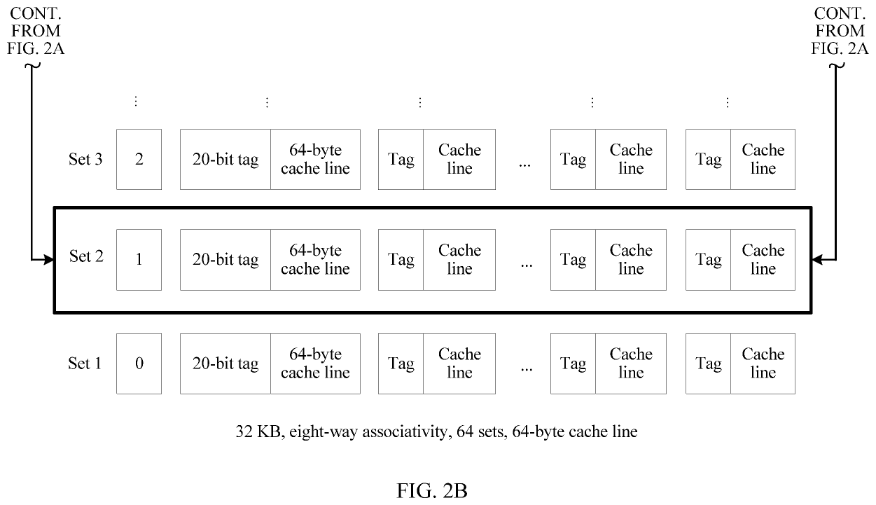

FIG. 2A and FIG. 2B are schematic diagrams of a cache structure according to an embodiment of the present disclosure. During cache access, a memory address is divided into three segments, a tag, an index, and an offset. When accessing data, a processor first searches a cache according to the memory address to determine whether the cache includes data corresponding to the memory address, and if a hit occurs, directly reads the data from the cache. If the cache does not include the data corresponding to the memory address, the processor obtains, from a memory, the data corresponding to the memory address, and writes the obtained data into the cache. As shown in FIG. 2A and FIG. 2B, the memory address includes 32 bits (bit), the cache has a capacity of 32 kilobytes (KB), includes 64 sets, and is eight-way set associative (in other words, each set includes eight cache lines), and each cache line includes 64 bytes in size.

Offset: An operation is performed in a unit of cache lines in the cache, and an internal address, in a cache line, of data needs to be determined using an offset. The cache line includes 64 bytes, and the offset may be indicated using six least significant bits of the address.

Index: The index is used to find a set to which the cache line belongs. In FIG. 2A and FIG. 2B, the cache includes 64 sets in total, and six middle bits of the address may be used to search for a set to which the address belongs.

Tag: During cache access, a set to which an access address belongs is first determined based on the index, and then each tag in the set is compared with a tag of the access address. If there is a same tag, it indicates a cache hit. If there is no same tag, a cache miss occurs. In FIG. 2A and FIG. 2B, after the set is found based on the index, each tag (remaining bits in the address, 20 most significant bits of the address in FIG. 2A and FIG. 2B) in eight cache lines in the set is compared with the tag of the access address.

A cache line can be uniquely determined based on a tag and an index.

It should be understood that, FIG. 2A and FIG. 2B merely describe the cache structure using an example, and an actual specification of the cache is not limited in this embodiment of the present disclosure.

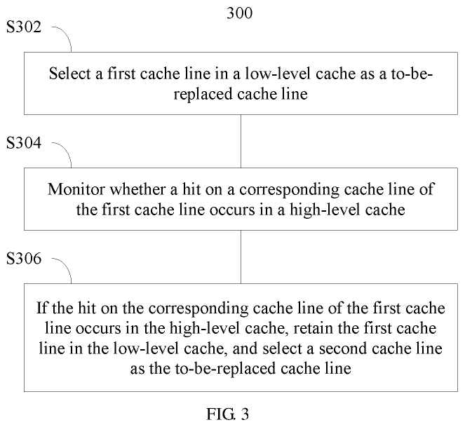

FIG. 3 is a flowchart of a cache replacement method 300 according to an embodiment of the present disclosure. The method 300 is applied to a computer system including a high-level cache and a low-level cache. The low-level cache and the high-level cache are in an inclusion relationship. In an embodiment, corresponding cache lines of all cache lines in the high-level cache are in the low-level cache. As shown in FIG. 3, the method 300 includes the following steps.

S302: A processor selects a first cache line in the low-level cache as a to-be-replaced cache line.

When the low-level cache is full and a cache miss occurs, the processor cannot find a blank space to store a missing cache line, and needs to use a space in which a cache line has been stored, in other words, replaces an existing cache line in the low-level cache with a new cache line.

The to-be-replaced cache line is replaced, when a cache miss occurs in the low-level cache, with a missing cache line. In other words, when a cache miss occurs in the low-level cache, the to-be-replaced cache line is evicted from the low-level cache, to release a space for a missing cache line.

In this embodiment of the present disclosure, a cache algorithm for selecting the first cache line in the low-level cache as the to-be-replaced cache line is not limited. The cache algorithm may be an algorithm such as first in first out (FIFO), last in first out (LIFO), LRU, pseudo-LRU (PLRU), random replacement (RR), segmented LRU (SLRU), least frequently used (LFU), LFU with dynamic aging (LFUDA), low inter-reference recency set (LIRS), adaptive replacement cache (ARC), or multi-queue (MQ).

For example, the processor may select the first cache line in the low-level cache as the to-be-replaced cache line according to an LRU policy.

S304: The processor monitors whether a cache hit on a corresponding cache line of the first cache line occurs in the high-level cache.

After selecting the first cache line in the low-level cache as the to-be-replaced cache line, the processor monitors whether the cache hit on the corresponding cache line of the first cache line occurs in the high-level cache. According to time and space characteristics of cache access, if data corresponding to the first cache line is frequently accessed data (hot data) in the high-level cache, before a subsequent cache miss occurs in the low-level cache, the corresponding cache line of the first cache line is hit in the high-level cache at a high probability.

If a cache miss occurs in the high-level cache, but the low-level cache includes a cache line corresponding to a missing cache line in the high-level cache, data corresponding to the missing cache line may be directly written into the high-level cache. In this case, no cache miss occurs in the low-level cache. A cache miss occurs in the low-level cache only when a cache miss occurs in the high-level cache and the low-level cache does not include a cache line corresponding to a missing cache line in the high-level cache. Because the high-level cache has a smaller space than the low-level cache, if the corresponding cache line of the first cache line is frequently accessed data in the high-level cache, before a cache miss occurs in the low-level cache, the corresponding cache line of the first cache line is hit in the high-level cache at a high probability.

In this embodiment of the present disclosure, a cache line in a monitored state is indicated in the high-level cache using specific indication information. A cache line being in a monitored state means that the processor monitors whether a cache hit on the cache line in the high-level cache occurs. A manner for indicating that the corresponding cache line of the first cache line is in a monitored state is not limited in this embodiment of the present disclosure.

In an embodiment of the present disclosure, the processor may store an identifier of the cache line in a monitored state using a status register, and the identifier may be a tag and an index of the cache line. After selecting the first cache line in the low-level cache as the to-be-replaced cache line, the processor writes an identifier of the first cache line into the status register (the first cache line and the corresponding cache line of the first cache line have the same identifier). The monitoring whether a cache hit on a corresponding cache line of the first cache line occurs in the high-level cache may include comparing an identifier of a hit cache line in the high-level cache with the identifier, stored in the status register, of the first cache line. If the two identifiers are the same, it indicates that the cache hit on the corresponding cache line of the first cache line occurs.

In another embodiment of the present disclosure, the processor may record a status of a cache line using an indication flag bit corresponding to the cache line, for example, may extend a tag field of the cache line by one bit as an indication flag. Each cache line in the high-level cache corresponds to an indication flag bit. When the indication flag bit is in a first state, it indicates that the corresponding cache line is not in a monitored state, and when the indication flag bit is in a second state, it indicates that the corresponding cache line is in a monitored state. The processor monitors only a cache line whose indication flag bit is in the second state. After selecting the first cache line in the low-level cache as the to-be-replaced cache line, the processor searches the high-level cache for the corresponding cache line of the first cache line, and sets an indication flag bit of the corresponding cache line of the first cache line to the second state. The monitoring whether a cache hit on a corresponding cache line of the first cache line occurs in the high-level cache may include monitoring, by the processor, whether a hit occurs on the corresponding cache line, whose indication flag bit is in the second state, of the first cache line.

S306: If the hit on the corresponding cache line of the first cache line occurs in the high-level cache before a cache miss occurs in the low-level cache, retain the first cache line in the low-level cache, and select a second cache line as the to-be-replaced cache line.

In an embodiment, the processor may select a second cache line other than the first cache line as the to-be-replaced cache line according to a cache replacement algorithm. For example, the processor may select a least recently used second cache line other than the first cache line as the to-be-replaced cache line according to the LRU algorithm.

If the high-level cache includes the corresponding cache line of the first cache line, and the hit on the corresponding cache line of the first cache line occurs in the high-level cache before a cache miss occurs in the low-level cache, it indicates that the corresponding cache line of the first cache line is frequently accessed data (hot data) in the high-level cache. To avoid back invalidation of the corresponding cache line, which is hot data, of the first cache line, the processor retains the first cache line in the low-level cache, and selects the second cache line as the to-be-replaced cache line. Because the corresponding cache line of the first cache line is hot data in the high-level cache, the processor may update a status of the first cache line in the low-level cache to “most recently used”.

Further, after the cache hit on the corresponding cache line of the first cache line occurs, the corresponding cache line of the first cache line is no longer monitored in the high-level cache. In an embodiment, if the identifier of the first cache line is recorded in the high-level cache using the status register, the identifier, recorded in the status register, of the first cache line is deleted. If whether the corresponding cache line of the first cache line is in a monitored state is indicated in the high-level cache using the indication flag bit, when the indication flag bit is in the first state, it indicates that the corresponding cache line is not in a monitored state, and when the indication flag bit is in the second state, it indicates that the corresponding cache line is in a monitored state, the indication flag bit of the corresponding cache line of the first cache line is set to the first state in the high-level cache, to stop monitoring the corresponding cache line of the first cache line.

If access to the corresponding cache line of the first cache line does not occur in the high-level cache before a cache miss occurs in the low-level cache, when the cache miss occurs in the low-level cache, the first cache line is evicted from the low-level cache, and a missing cache line is moved into the low-level cache.

In an embodiment, if the high-level cache includes the corresponding cache line of the first cache line, and the hit on the corresponding cache line of the first cache line does not occur in the high-level cache before a cache miss occurs in the low-level cache, the first cache line is evicted from the low-level cache when the cache miss occurs in the low-level cache. To ensure the inclusion relationship between the high-level cache and the low-level cache, the processor performs back invalidation on the corresponding cache line, in the high-level cache, of the first cache line. Further, the processor stops monitoring, in the high-level cache, the corresponding cache line of the first cache line. A specific manner has been described above, and details are not described herein again. The processor further writes a missing cache line into the low-level cache and the high-level cache.

If the high-level cache does not include the corresponding cache line of the first cache line, and the processor does not access the data of the first cache line before a subsequent cache miss occurs in the low-level cache, in other words, a cache miss on the corresponding cache line of the first cache line does not occur in the high-level cache before a subsequent cache miss occurs in the low-level cache, when the cache miss occurs in the low-level cache, the first cache line is evicted from the low-level cache, and a missing cache line is updated to the low-level cache and the high-level cache.

If the high-level cache does not include the corresponding cache line of the first cache line, and the processor accesses the data corresponding to the first cache line before a subsequent cache miss occurs in the low-level cache, in other words, an access operation on the data corresponding to the first cache line occurs in the high-level cache before a subsequent cache miss occurs in the low-level cache, because a cache miss on the corresponding cache line of the first cache line occurs in the high-level cache, the processor searches the low-level cache for the first cache line, and updates the data corresponding to the first cache line to the high-level cache. Therefore, a hit on the first cache line occurs in the low-level cache, and the processor retains the first cache line in the low-level cache, and selects the second cache line as the to-be-replaced cache line. This avoids back invalidation of the corresponding cache line, just updated to the high-level cache, of the first cache line. Further, the status of the first cache line may be updated to most recently used MRU in the low-level cache.

According to the technical solution disclosed in this embodiment of the present disclosure, after selecting the first cache line in the low-level cache as the to-be-replaced cache line, the processor monitors whether a hit on the corresponding cache line of the first cache line occurs in the high-level cache. If the hit on the corresponding cache line of the first cache line occurs, it indicates that the corresponding cache line of the first cache line is frequently accessed data (hot data) in the high-level cache. The processor retains the first cache line in the low-level cache, and selects the second cache line as the to-be-replaced cache line, thereby ensuring that the corresponding cache line, which is hot data, of the first cache line is not invalidated in the high-level cache due to replacement in the low-level cache, increasing a cache hit rate in the high-level cache, and improving overall system performance.

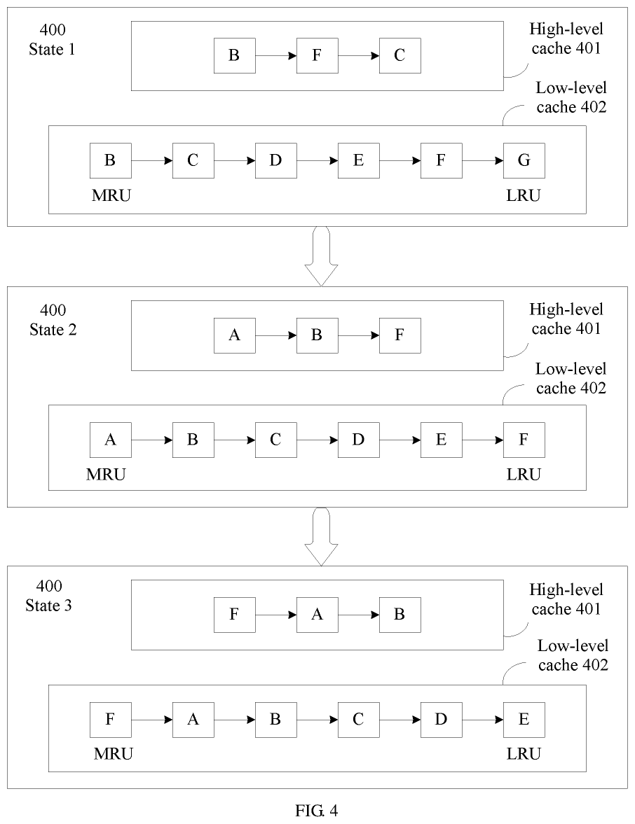

FIG. 4 is a schematic diagram of a cache status change according to an embodiment of the present disclosure. As shown in FIG. 4, a cache system 400 includes a high-level cache 401 and a low-level cache 402. In a state 1, the low-level cache 402 includes six cache lines B, C, D, E, F, and G, and the high-level cache 401 includes three cache lines B, F, and C. The high-level cache 401 and the low-level cache 402 are in an inclusion relationship. In an embodiment, the cache lines B, F, and C in the high-level cache are also in the low-level cache. The low-level cache maintains a logical LRU chain. During specific implementation, the LRU chain may be implemented by recording quantities or time of misses on the cache lines. An implementation form of the LRU chain is not limited in the present disclosure. In the state 1, a cache line at the end of the LRU chain is the cache line G. Therefore, according to a replacement policy, the cache line G is a to-be-replaced cache line, and when a subsequent cache miss occurs in the low-level cache, the to-be-replaced cache line is replaced with a missing cache line. In an embodiment, when a subsequent cache miss occurs in the low-level cache 402, the cache line G is evicted from the low-level cache 402.

In the state 1, if the processor initiates access to data A, because the high-level cache 401 does not include a cache line corresponding to the data A, a cache miss on the data A occurs in the high-level cache 401, and the processor searches the low-level cache 402 to determine whether the low-level cache 402 includes the data A. Because the low-level cache 402 does not include the data A either, the cache miss on the data A also occurs in the low-level cache, and the processor obtains the data A from a lower-level cache or a memory, and updates the cache line corresponding to the data A to the low-level cache 402 and the high-level cache 401. The cache system enters a state 2.

As shown in FIG. 4, in the state 2, a cache line A is updated to the low-level cache 402 and the high-level cache 401, the to-be-replaced cache line G in the state 1 is evicted from the low-level cache 402, and the cache line C in the state 1 is evicted from the high-level cache 401. In the state 2, the newly added cache line A is at the beginning of the LRU chain, and the cache line F is at the end of the LRU chain. Therefore, in the state 2, the cache line F is the to-be-replaced cache line in the low-level cache 402.

In the state 2, after determining the cache line F in the low-level cache 402 as the to-be-replaced cache line, the processor monitors whether a hit on the cache line F occurs in the high-level cache 401. If a hit on the cache line F occurs in the high-level cache 401 before the cache line F is replaced in the low-level cache 402 because a cache miss occurs in the low-level cache 402, it indicates that the cache line F is hot data in the high-level cache 401. To avoid back invalidation of the cache line F in the high-level cache, the processor retains the cache line F in the low-level cache 402, and selects the cache line E as the to-be-replaced cache line. The cache system enters a state 3.

As shown in the figure, in the state 3, because the hit on the cache line F occurs in the high-level cache, in an updated LRU chain in the low-level cache, the cache line F is adjusted to MRU and is at the beginning of the LRU chain, and the cache line E is at the end of the LRU chain and is selected as the to-be-replaced cache line.

According to the technical solution disclosed in this embodiment of the present disclosure, after determining the cache line F as the to-be-replaced cache line in the low-level cache 402, the processor monitors whether the hit on the cache line F occurs in the high-level cache 401 before the cache line F is evicted from the low-level cache 402 because a cache miss occurs in the low-level cache 402. If the hit on the cache line F occurs in the high-level cache 401, it indicates that the cache line F is hot data. To avoid back invalidation of the cache line F, the processor retains the cache line F in the low-level cache 402, and selects the cache line E as the to-be-replaced cache line, thereby ensuring that the cache line F that is hot data stays in the high-level cache 401, increasing a cache hit rate in the high-level cache, and improving overall system performance of the processor.

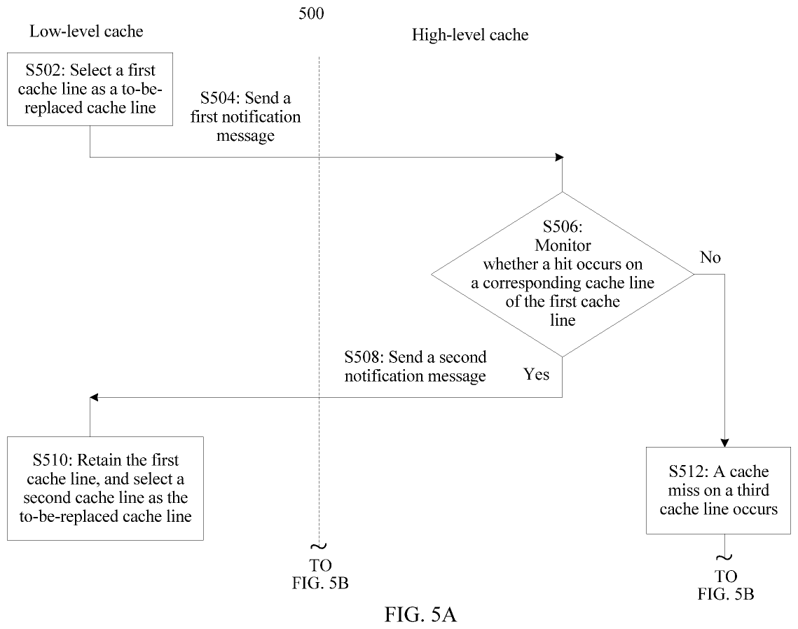

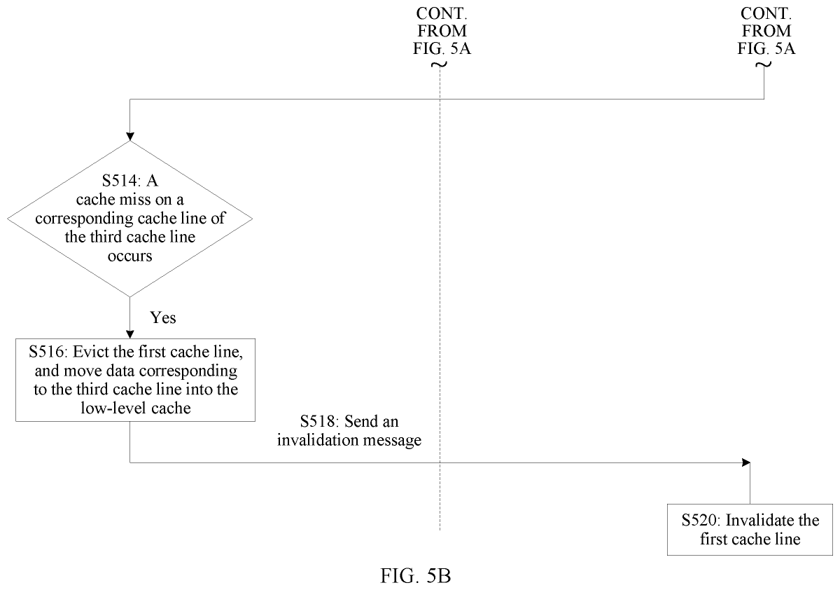

FIG. 5A and FIG. 5B are example flowcharts of a cache replacement method 500 according to an embodiment of the present disclosure. A cache architecture includes a low-level cache and a high-level cache, and the low-level cache and the high-level cache have respective control logic. As shown in FIG. 5A and FIG. 5B, the method 500 includes the following steps.

S502: The low-level cache selects a first cache line as a to-be-replaced cache line.

A policy for the low-level cache to select the to-be-replaced cache line has been described above, and details are not described again. For ease of description, it is assumed in this embodiment of the present disclosure that the low-level cache selects the first cache line as the to-be-replaced cache line according to an LRU replacement policy. When a status update occurs, a first cache line in an LRU state is determined as the first cache line.

S504: The low-level cache sends a first notification message to the high-level cache.

The first notification message is used to notify the high-level cache that the first cache line is determined by the low-level cache as the to-be-replaced cache line. The first notification message includes indication information of the first cache line. The indication information may be an index and tag information of the first cache line. This is not limited in this embodiment of the present disclosure.

During a specific implementation, the low-level cache may send the first notification message to the high-level cache when the first cache line is updated to the LRU state during the status update.

After receiving the first notification message sent by the low-level cache, the high-level cache first searches the high-level cache based on the indication information of the first cache line to determine whether the high-level cache includes a corresponding cache line of the first cache line. If the high-level cache does not include the corresponding cache line of the first cache line, the high-level cache may discard the first notification message. If the high-level cache includes the corresponding cache line of the first cache line, the high-level cache performs step S506. For ease of description, it is assumed in this embodiment of the present disclosure that both the high-level cache and the low-level cache include the first cache line. A case in which the low-level cache includes the first cache line but the high-level cache does not include the first cache line has been described in the embodiment of FIG. 3, and details are not described again in this embodiment of the present disclosure. In the following description of this embodiment of the present disclosure, unless otherwise stated, it is assumed that the high-level cache includes the first cache line.

S506: The high-level cache monitors whether a hit on the corresponding cache line of the first cache line occurs in the high-level cache before a cache miss occurs in the low-level cache. If the hit occurs, step S508 is performed. If no hit occurs, step S512 is performed.

During a specific implementation, the high-level cache may mark the corresponding cache line of the first cache line in a plurality of manners, to indicate that the corresponding cache line of the first cache line is in a monitored state. The high-level cache may record an identifier of the first cache line (the identifier of the first cache line is the same as an identifier of the corresponding cache line of the first cache line) using a register, or indicate the corresponding cache line of the first cache line using a flag bit. For example, a one-bit flag bit FI may be added to a tag of a cache line, and both an initial value and a reset value of the flag bit FI are 0. After the high-level cache receives the first notification message, if the corresponding cache line of the first cache line is in the high-level cache, the high-level cache sets a flag bit FI of the corresponding cache line of the first cache line to 1, to indicate that the corresponding cache line of the first cache line is in a monitored state.

If the hit on the corresponding cache line of the first cache line occurs before the high-level cache receives a back invalidation message for the first cache line from the low-level cache, step S508 is performed. Moreover, monitoring the corresponding cache line of the first cache line is stopped. If the high-level cache records the identifier of the first cache line using the register, the high-level cache deletes the identifier, recorded in the register, of the first cache line. If the high-level cache indicates, using the flag bit FI, that the corresponding cache line of the first cache line is in a monitored state, the high-level cache sets the flag bit FI corresponding to the corresponding cache line of the first cache line to 0.

In an embodiment, if the high-level cache records the identifier of the first cache line using the register, for each cache hit that occurs in the high-level cache, the high-level cache compares an identifier of a cache line on which the cache hit occurs with the identifier, stored in the register, of the first cache line. If the two identifiers are the same, it indicates that the hit on the corresponding cache line of the first cache line occurs. Therefore, step S508 is triggered, and the identifier, recorded in the register, of the first cache line is deleted. If the high-level cache indicates, using the flag bit FI, that the corresponding cache line of the first cache line is in a monitored state, if a cache hit occurs in the high-level cache and a flag bit FI corresponding to a hit cache line is 1, it indicates that the hit on the corresponding cache line of the first cache line occurs. Therefore, step S508 is triggered, and the flag bit FI corresponding to the corresponding cache line of the first cache line is set to 0.

S508: The high-level cache sends a second notification message to the low-level cache.

The second notification message is used to indicate that the hit on the corresponding cache line of the first cache line occurs in the high-level cache.

S510: The low-level cache retains the first cache line, and selects a second cache line as the to-be-replaced cache line.

Because the hit on the corresponding cache line of the first cache line occurs in the high-level cache, according to time and space characteristics of cache access, it indicates that the corresponding cache line of the first cache line is hot data in the high-level cache. To avoid back invalidation, in the high-level cache, of the corresponding cache line of the first cache line, the low-level cache retains the first cache line, and selects the to-be-replaced cache line.

Further, the low-level cache may update a status of the first cache line to MRU. After the status is updated, the second cache line in the LRU state is determined as the to-be-replaced cache line. It should be understood that, this embodiment of the present disclosure is merely described using the LRU policy as an example, and a cache algorithm for selecting the second cache line as the to-be-replaced cache line is not limited in this embodiment of the present disclosure.

S512: A cache miss on a third cache line occurs in the high-level cache.

Because the high-level cache has a smaller space and is closer to a processor core, cache line replacement occurs more frequently, and after the high-level cache receives the first notification message, a cache miss occurs soon in the high-level cache. After the cache miss on the third cache line occurs in the high-level cache, the high-level cache searches the low-level cache to determine whether the low-level cache includes a corresponding cache line of the third cache line.

S514: The low-level cache determines whether a cache miss occurs on the corresponding cache line of the third cache line.

If the low-level cache includes the corresponding cache line of the third cache line, data of the corresponding cache line of the third cache line may be directly updated to the high-level cache. Because no cache miss occurs in the low-level cache, the first cache line serving as the to-be-replaced cache line is not evicted from the low-level cache.

If the low-level cache does not include the corresponding cache line of the third cache line, the cache miss on the corresponding cache line of the third cache line occurs in the low-level cache, and the low-level cache needs to obtain, from a lower-level cache or a memory, the data corresponding to the third cache line, and perform step S516.

S516: The low-level cache evicts the first cache line, and moves data corresponding to the third cache line into the low-level cache.

Because the cache miss on the corresponding cache line of the third cache line occurs, after obtaining, from the lower-level cache or the memory, the data corresponding to the third cache line, the low-level cache replaces the current to-be-replaced cache line (the first cache line) with the data corresponding to the third cache line, and writes the data corresponding to the third cache line into the high-level cache.

S518: The low-level cache sends an invalidation message to the high-level cache.

To ensure an inclusion relationship, after evicting the first cache line, the low-level cache needs to send the invalidation message for the corresponding cache line of the first cache line to the high-level cache, to invalidate the corresponding cache line, in the high-level cache, of the first cache line. The invalidation message may carry identification information of the first cache line, and the identification information may be the index and tag information of the first cache line.

S520: The high-level cache invalidates the corresponding cache line of the first cache line.

After receiving the invalidation message for the corresponding cache line of the first cache line, the high-level cache invalidates the corresponding cache line of the first cache line. In an embodiment, the high-level cache may search for the corresponding cache line of the first cache line based on the identifier, carried in the invalidation message, of the first cache line, and if the corresponding cache line of the first cache line is found, mark the corresponding cache line of the first cache line as invalid. Further, the high-level cache stops monitoring the corresponding cache line of the first cache line.

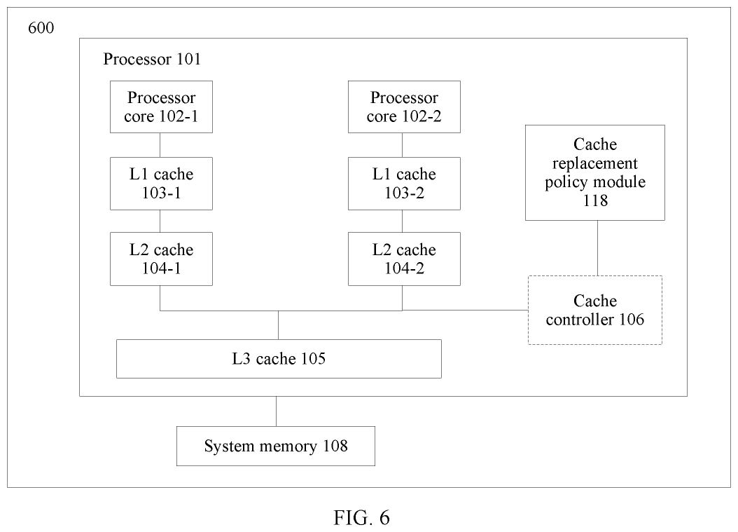

FIG. 6 is a schematic diagram of a logical structure of a cache replacement system 600 according to an embodiment of the present disclosure. As shown in FIG. 6, the system 600 includes a processor 101. The processor 101 includes a three-level cache architecture and two processor cores, a processor core 102-1 and a processor core 102-2. An L1 cache 103-1 and an L2 cache 104-1 are private caches of the processor core 102-1. An L1 cache 103-2 and an L2 cache 104-2 are private caches of the processor core 102-2. An L3 cache 105 is a cache shared between the processor core 102-1 and the processor core 102-2. The processor 101 is interconnected with a system memory 108.

It should be understood that, the system 600 is merely an example for description, and a cache replacement policy in the embodiments of the present disclosure is applicable to a data replacement system including an architecture with more levels (greater than three levels) of caches, and also applicable to a data replacement system including a two-level cache architecture.

The processor 101 further includes a cache replacement policy module 118, and the cache replacement policy module 118 is firmware integrated into the processor 101.

Further, the processor 101 may further include a cache controller 106.

When the processor 101 or the cache controller 106 executes the cache replacement policy module 118, the method described in any one of embodiments of FIG. 3 to FIG. 5B in the embodiments of the present disclosure is performed. A specific procedure has been described above, and details are not described herein again.

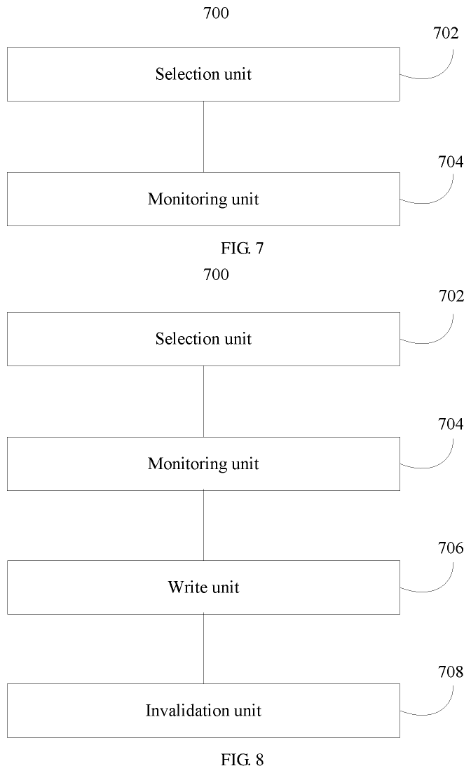

FIG. 7 is a schematic diagram of a logical structure of a cache replacement apparatus 700 according to an embodiment of the present disclosure. The apparatus 700 is applied to a computer system. The computer system includes a high-level cache and a low-level cache. The low-level cache and the high-level cache are in an inclusion relationship. As shown in FIG. 7, the apparatus 700 includes a selection unit 702 and a monitoring unit 704.

The selection unit 702 is configured to select a first cache line in the low-level cache as a to-be-replaced cache line. The to-be-replaced cache line is evicted from the low-level cache when a cache miss occurs in the low-level cache.

The monitoring unit 704 is configured to monitor whether a hit on a corresponding cache line of the first cache line occurs in the high-level cache. If the hit on the corresponding cache line of the first cache line occurs in the high-level cache before a cache miss occurs in the low-level cache, the selection unit 702 is further configured to retain the first cache line in the low-level cache, and select a second cache line as the to-be-replaced cache line.

As shown in FIG. 8, the apparatus 700 may further include a write unit 706 and an invalidation unit 708.

Optionally, the high-level cache is associated with a status register, and the status register is configured to store an identifier of a cache line in a monitored state. After the selection unit 702 selects the first cache line in the low-level cache as the to-be-replaced cache line, the write unit 706 is configured to write an identifier of the first cache line into the status register. The monitoring unit 704 is configured to compare an identifier of a hit cache line in the high-level cache with the identifier, stored in the status register, of the first cache line. If the two identifiers are the same, it indicates that the hit on the corresponding cache line of the first cache line occurs.

Optionally, each cache line in the high-level cache corresponds to an indication flag bit, when the indication flag bit is in a first state, it indicates that the corresponding cache line is not in a monitored state, and when the indication flag bit is in a second state, it indicates that the corresponding cache line is in a monitored state. After the selection unit 702 selects the first cache line in the low-level cache as the to-be-replaced cache line, the monitoring unit 704 is further configured to search the high-level cache for the corresponding cache line of the first cache line, and set an indication flag bit corresponding to the corresponding cache line of the first cache line to the second state.

If access to the corresponding cache line of the first cache line does not occur in the high-level cache before a cache miss occurs in the low-level cache, when the cache miss occurs in the low-level cache, the write unit 706 is further configured to evict the first cache line from the low-level cache, and move a missing cache line into the low-level cache. After the write unit 706 evicts the first cache line from the low-level cache, the invalidation unit 708 is configured to perform back invalidation on the corresponding cache line, in the high-level cache, of the first cache line.

Optionally, the selection unit 702 is configured to select the first cache line in the low-level cache as the to-be-replaced cache line according to a least recently used LRU policy. If the hit on the corresponding cache line of the first cache line occurs in the high-level cache before a cache miss occurs in the low-level cache, the selection unit 702 is further configured to update a status of the first cache line in the low-level cache to “MRU”.

In this embodiment of the present disclosure, the selection unit 702, the monitoring unit 704, the write unit 706, and the invalidation unit 708 may be implemented by the processor 101 by executing code in the cache replacement policy module 118.

This embodiment of the present disclosure is an apparatus embodiment corresponding to the method embodiments of FIG. 3 to FIG. 6, descriptions of features in the embodiment parts of FIG. 3 to FIG. 6 are applicable to this embodiment of the present disclosure, and details are not described herein again.

The foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make replacements to some technical features thereof, without departing from the protection scope of the claims.

What is claimed is:

1. A cache replacement method performed by a computer comprising a high-level cache and a low-level cache, the low-level cache and the high-level cache are in an inclusive relationship, and wherein the cache replacement method comprises:
selecting a first cache line in the low-level cache as a to-be-replaced cache line in response to a cache miss occurring in the low-level cache, wherein the to-be-replaced cache line is evicted from the low-level cache when a cache miss occurs in the low-level cache;
monitoring whether a hit on a corresponding cache line of the first cache line occurs in the high-level cache; and
in response to the hit on the corresponding cache line of the first cache line occurring in the high-level cache before the cache miss occurs in the low-level cache:
retaining the first cache line in the low-level cache; and
selecting a second cache line as the to-be-replaced cache line.

2. The cache replacement method according to claim 1, wherein the high-level cache is associated with a status register configured to store an identifier of a cache line in a monitored state, wherein after selecting the first cache line in the low-level cache as the to-be-replaced cache line, the method further comprises:
writing an identifier of the first cache line into the status register; and
comparing an identifier of a hit cache line in the high-level cache with the identifier of the first cache line stored in the status register, wherein the hit on the corresponding cache line of the first cache line occurs in response to the identifier of the hit cache line in the high-level cache and the identifier of the first cache line matching.

3. The cache replacement method according to claim 1, wherein each cache line in the high-level cache corresponds to an indication flag bit, wherein the indication flag bit being in a first state indicates that the corresponding cache line is not in a monitored state, wherein the indication flag bit being in a second state indicates that the corresponding cache line is in the monitored state, and wherein after selecting the first cache line in the low-level cache as the to-be-replaced cache line, the method further comprises:
searching the high-level cache for the corresponding cache line of the first cache line; and
setting the indication flag bit associated with the corresponding cache line of the first cache line to the second state.

4. The cache replacement method according to claim 1, further comprising evicting the first cache line from the low-level cache in response to the cache miss occurring in the low-level cache and in response to the cache miss occurring in the low-level cache after access to the corresponding cache line of the first cache line not occurring in the high-level cache.

5. The cache replacement method according to claim 4, further comprising invalidating the corresponding cache line of the first cache line in the high-level cache after evicting the first cache line from the low-level cache.

6. The cache replacement method according to claim 1, further comprising selecting the first cache line in the low-level cache as the to-be-replaced cache line according to a least recently used (LRU) policy.

7. The cache replacement method according to claim 6, further comprising updating a status of the first cache line in the low-level cache to “most recently used (MRU)” in response to the hit on the corresponding cache line of the first cache line occurring in the high-level cache before the cache miss occurs in the low-level cache.

8. A system for cache replacement, comprising:
a high-level cache;
a low-level cache, wherein the low-level cache and the high-level cache are in an inclusive relationship; and
a cache controller, and the low-level cache and the high-level cache are in an inclusion relationship; and
the a cache controller coupled to the high-level cache and the low-level cache, wherein the cache controller is configured to:
select a first cache line in the low-level cache as a to-be-replaced cache line in response to a cache miss occurring in the low-level cache, wherein the to-be-replaced cache line is evicted from the low-level cache when a cache miss occurs in the low-level cache; monitor whether a hit on a corresponding cache line of the first cache line occurs in the high-level cache; and
in response to the hit on the corresponding cache line of the first cache line occurring in the high-level cache before the cache miss occurs in the low-level cache:
retain the first cache line in the low-level cache; and
select a second cache line as the to-be-replaced cache line.

9. The system according to claim 8, wherein the system further comprises a status register, wherein the status register is associated with the high-level cache and configured to store an identifier of a cache line in a monitored state, wherein after selecting the first cache line in the low-level cache as the to-be-replaced cache line, the cache controller is further configured to:
write an identifier of the first cache line into the status register; and
compare an identifier of a hit cache line in the high-level cache with the identifier of the first cache line stored in the status register, wherein the hit on the corresponding cache line of the first cache line occurs in response to the identifier of the hit cache line in the high-level cache and the identifier of the first cache line matching.

10. The system according to claim 8, wherein each cache line in the high-level cache corresponds to an indication flag bit, wherein the indication flag bit being in a first state indicates that the corresponding cache line is not in a monitored state, wherein the indication flag bit being in a second state indicates that the corresponding cache line is in the monitored state, and wherein, after selecting the first cache line in the low-level cache as the to-be-replaced cache line, the cache controller is further configured to:
search the high-level cache for the corresponding cache line of the first cache line; and
set the indication flag bit associated with the corresponding cache line of the first cache line to the second state.

11. The system according to claim 8, wherein the first cache line is evicted from the low-level cache in response to the cache miss occurring in the low-level cache and in response to the cache miss occurring in the low-level cache after access to the corresponding cache line of the first cache line not occurring in the high-level cache.

12. The system according to claim 11, wherein the cache controller is further configured to invalidate the corresponding cache line of the first cache line in the high-level cache after evicting the first cache line from the low-level cache.

13. The system according to claim 8, wherein the first cache line in the low-level cache is selected as the to-be-replaced cache line according to a least recently used (LRU) policy.

14. The system according to claim 13, wherein the cache controller is further configured to update a status of the first cache line in the low-level cache to “most recently used (MRU)” in response to the hit on the corresponding cache line of the first cache line occurring in the high-level cache before the cache miss occurs in the low-level cache.

15. A non-transitory readable medium comprising instructions executable by a processor such that when executed, cause the processor to be configured to:
select a first cache line in a low-level cache as a to-be-replaced cache line in response to a cache miss occurring in the low-level cache, wherein the to-be-replaced cache line is evicted from the low-level cache when a cache miss occurs in the low-level cache;
monitor whether a hit on a corresponding cache line of the first cache line occurs in a high-level cache; and
in response to the hit on the corresponding cache line of the first cache line occurring in the high-level cache before the cache miss occurs in the low-level cache:
retain the first cache line in the low-level cache; and
select a second cache line as the to-be-replaced cache line.

16. The non-transitory readable medium according to claim 15, wherein the high-level cache is associated with a status register configured to store an identifier of a cache line in a monitored state, wherein after selecting the first cache line in the low-level cache as the to-be-replaced cache line, the instructions further cause the processor to be configured to:
write an identifier of the first cache line into the status register;
compare an identifier of a hit cache line in the high-level cache with the identifier of the first cache line stored in the status register, wherein the hit on the corresponding cache line of the first cache line occurs in response to the identifier of the hit cache line in the high-level cache and the identifier of the first cache line matching.

17. The non-transitory readable medium according to claim 15, wherein each cache line in the high-level cache corresponds to an indication flag bit, wherein the indication flag bit being in a first state indicates that the corresponding cache line is not in a monitored state, wherein the indication flag bit being in a second state indicates that the corresponding cache line is in the monitored state, and wherein, after selecting the first cache line in the low-level cache as the to-be-replaced cache line, the instructions further cause the processor to be configured to:
search the high-level cache for the corresponding cache line of the first cache line; and
set the indication flag bit associated with the corresponding cache line of the first cache line to the second state.

18. The non-transitory readable medium according to claim 15, wherein the first cache line is evicted from the low-level cache in response to the cache miss occurring in the low-level cache and in response to the cache miss occurring in the low-level cache after access to the corresponding cache line of the first cache line not occurring in the high-level cache.

19. The non-transitory readable medium according to claim 18, wherein after evicting the first cache line from the low-level cache, the instructions further cause the processor to be configured to invalidate the corresponding cache line of the first cache line in the high-level cache.

20. The non-transitory readable medium according to claim 15, wherein the first cache line in the low-level cache is selected as the to-be-replaced cache line according to a least recently used (LRU) policy.
